(19) United States
(12) Patent Application Publication
(10) Pub. No.: US 2011/0196559 A1
(43) Pub. Date: Aug. 11, 2011

(54) Process for Operating a Hybrid Vehicle

(75) Inventor: Florian PREUSS, Muenchen (DE)

(73) Assignee: Bayerische Motoren Werke Aktiengesellschaft, Muenchen (DE)

(21) Appl. No.: 13/089,848

(22) Filed: Apr. 19, 2011

Related U.S. Application Data
(63) Continuation of application No. PCT/EP2009/008729, filed on Dec. 8, 2009.

(30) Foreign Application Priority Data
Jan. 30, 2009 (DE) 10 2009 006 750.7

(51) Int. Cl. G06F 19/00

(52) U.S. Cl. 701/22; 180/65.23; 903/902

(57) ABSTRACT

A process for operating a hybrid vehicle is provided wherein a change from an internal-combustion-engine operating mode to an electric motor operating mode, at least under some operating conditions, takes place as a function of location information locally present along the driving route. By way of a user interface, at least one location information can be defined or selected, in the presence of which a change is to be triggered from the internal-combustion engine operating mode to the electric motor operating mode.

### CROSS-REFERENCE TO RELATED APPLICATIONS

This application is a continuation of PCT International Application No. PCT/EP2009/008729, filed Dec. 8, 2009, which claims priority under 35 U.S.C. §119 from German Patent Application No. DE 10 2009 006 750.7, filed Jan. 30, 2009, the entire disclosures of which are herein expressly incorporated by reference.

### BACKGROUND AND SUMMARY OF THE INVENTION

The present invention relates to a process for operating a hybrid vehicle, wherein a change from an internal-combustion-engine operating mode to an electric motor operating mode, at least under some operating conditions, takes place as a function of location information locally present along the driving route.

Such a process for operating a hybrid vehicle is known from German Patent document DE 10 2005 047 513 A1.

It is known that hybrid vehicles are distinguished by a combination of an internal-combustion engine and at least one electric motor. So-called “full hybrids” are capable of optionally being driven only by an internal-combustion engine, only by an electric motor, or by an internal-combustion engine assisted by an electric motor. For optimizing the energy efficiency of the vehicle, a very complex operating strategy is usually implemented in the hybrid control unit which, as a function of a plurality of input parameters, automatically carries out a change between the individual conceivable operating modes without any action being required by the driver.

A very significant aspect for the selection of the operating mode is the limited storage capacity of the available electric energy accumulator. Naturally, purely electric driving is not possible in all operating conditions or driving situations in which it is advantageous with respect to energy or in which it is desired by the driver. Since, in the case of conventional hybrid vehicles, the current operating mode is automatically selected by a hybrid control unit whose operating strategy is precisely defined and cannot be actively changed by the driver, cases may also occur in which the hybrid control unit keeps the vehicle in the internal-combustion engine operating mode in driving situations in which electrical driving would be technically possible and is desired by the driver.

It is an object of the invention to indicate a process for operating a hybrid vehicle where an active influencing of the operating strategy of the hybrid vehicle becomes possible.

This and other objects are achieved by a process according to the invention for operating a hybrid vehicle wherein a change from an internal-combustion-engine operating mode to an electric motor operating mode, at least under some operating conditions, takes place as a function of location information locally present along the driving route. By way of a user interface, at least one location information can be defined or selected, or is defined or selected, in the presence of which a change from the internal-combustion engine operating mode to the electric motor operating mode is to be initiated.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a flowchart illustrating an exemplary process for operating a hybrid vehicle in accordance with the invention.

### DETAILED DESCRIPTION OF ONE OR MORE PREFERRED EMBODIMENTS

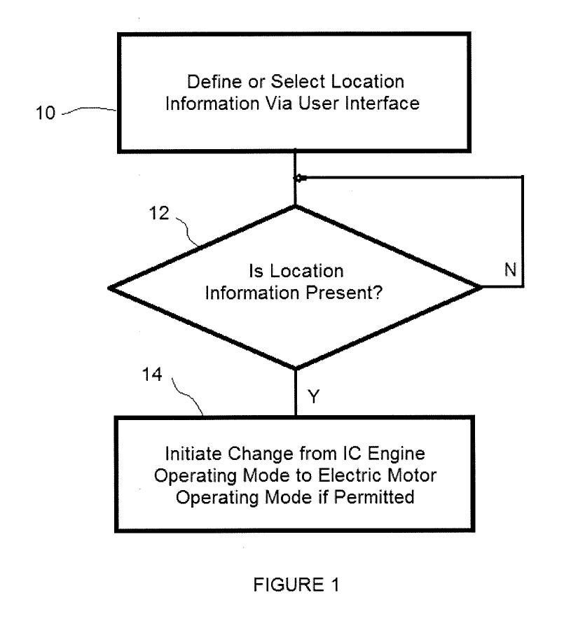

FIG. 1 is an exemplary flowchart illustrating a process for operating a hybrid vehicle, wherein a change from an internal-combustion engine operating mode to an electric motor operating mode, at least under some operating conditions, takes place as a function of location information locally present along the driving route.

The term “location information” should be understood in a very broad sense. It may, for example, be provided that on route sections where “the hybrid vehicle can recognize” that it is in the proximity or in the immediate surroundings of certain facilities, such as a kindergarten, a gas station, a “home address”, an opera, a hotel, or the like, the driving is to be only electric if permitted by the other marginal conditions, such as the charge state of the energy accumulator, the desired speed defined by the driver, the temperature of the energy accumulator, etc.

In accordance with the figure, by way of a “user interface”, one or more “pieces of location information” can be actively defined or selected (step 10). If they are present (step 12), a change is to be triggered from an operation by the internal-combustion engine to an operation by the electric motor if permitted by the remaining marginal conditions (step 14).

The term “user interface” should also be interpreted in a broad fashion. It may, for example, be provided that the driver of the hybrid vehicle can define or select “location information” by way of an input or selection function of a navigation system communicating with the hybrid vehicle or fixedly installed in the hybrid vehicle. When this “location information” is present or is “occurring”, the hybrid control unit switches to the electric operating mode if permitted by the other marginal conditions.

Thus, it may be provided that certain route points and surroundings of route points can be defined or selected, at which or within which, if possible and permitted, the driving is to take place in the electric operating mode. The environment of such a route point or location can be determined, for example, by defining a certain radius around the corresponding location.

As an alternative, it also could, for example, be specified that, within certain municipalities, i.e. from arriving within the town limits to leaving the town, the driving should only be electric, if possible.

Furthermore, it could be specified that the driving is to be purely electric within a certain distance from a destination point of the driving route.

It may also be provided that certain categories of locations, such as “kindergarten”, “gas station”, “opera”, “hotel”, etc., and a respectively assigned “environment”, for example, a certain radius, can be defined or selected within which, the driving is to be only electric, if possible.

In addition, it may be provided that the driving route to be traveled and determined by a navigation system is examined in an anticipatory fashion for route sections on which a purely electric driving is desired. Thus, it may be provided that, on the driving route to be traveled, at least the next route section (or the next two, three or four route sections, for example) are determined on which the driver wishes to drive only electrically and that, in an anticipatory fashion, the energy accumulator of the hybrid vehicle is maintained in a charge state or is charged to a charge state that permits purely electric driving through this route section or these route sections. A routine can therefore be provided which ensures, if technically possible, that sufficient electrical energy is provided in order to implement the driver's wish to drive purely electrically on defined route sections or in the surroundings of certain locations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for operating a hybrid vehicle having an internal-combustion engine operating mode, an electric motor operating mode, and a hybrid internal-combustion engine and electric motor operating mode, the process comprising the acts of:
receiving, via a user interface, at least one location information definable or selectable by a user;
determining an occurrence or presence of the at least one location information along a driving route of the hybrid vehicle; and
initiating a change from the internal-combustion engine operating mode to the electric motor operating mode upon determining the occurrence or presence of the at least one location information.

2. The process according to claim 1, wherein the receiving act occurs via a user interface of a navigation system of the hybrid vehicle.

3. The process according to claim 1, wherein the receiving of the at least one location information occurs via a data interface, and the at least one location information is stored into an electronic memory of the hybrid vehicle;
and further wherein the user interface by which the at least one location information is definable or selectable being located outside of the hybrid vehicle.

4. The process according to claim 1, wherein the receiving act further comprises the act of receiving at least one location and an assigned location environment definable or selectable by the user within which driving is to occur in the electric motor operating mode.

5. The process according to claim 2, wherein the receiving act further comprises the act of receiving at least one location and an assigned location environment definable or selectable by the user within which driving is to occur in the electric motor operating mode.

6. The process according to claim 1, wherein the receiving act further comprises the act of receiving a category of locations and an assigned environment or environments definable or selectable by the user within which driving is to occur in the electric motor operating mode.

7. The process according to claim 2, wherein the receiving act further comprises the act of receiving a category of locations and an assigned environment or environments definable or selectable by the user within which driving is to occur in the electric motor operating mode.

8. The process according to claim 1, wherein the receiving act further comprises the act of receiving a destination of a driving route and an environment around said destination that is definable or selectable by the user within which driving is to occur in the electric motor operating mode.

9. The process according to claim 2, wherein the receiving act further comprises the act of receiving a destination of a driving route and an environment around said destination that is definable or selectable by the user within which driving is to occur in the electric motor operating mode.

10. The process according to claim 4, wherein the assigned location environment is defined by a defined radius around the location.

11. The process according to claim 6, wherein the assigned location environment is defined by a defined radius around the location.

12. The process according to claim 8, wherein the assigned location environment is defined by a defined radius around the location.

13. The process according to claim 1, further comprising the acts of:
determining a driving route to be traveled via a navigation system;
determining in an anticipatory manner at least a next route section of the driving route during which driving is to be in the electric motor operating mode; and
providing an energy accumulator of the hybrid vehicle with a sufficiently high charge state, if possible, in order to operate the hybrid vehicle in the electric motor operating mode during the drive through the next route section.

14. A process for operating a hybrid vehicle having an internal-combustion engine operating mode, an electric motor operating mode, and a hybrid operating mode, the process comprising the acts of:
actively defining or selecting location information via a user interface; and
causing a change from the internal-combustion engine operating mode to the electric motor operating mode when the defined or selected location information occurs or is present along a driving route of the hybrid vehicle.

15. The process according to claim 14, wherein the location information comprises at least one location and an assigned location environment.

16. The process according to claim 14, wherein the location information comprises a category of locations and an assigned environment or assigned environments.

17. The process according to claim 14, wherein the location information comprises a driving route destination and an environment around said destination.
